(19) United States
(12) Patent Application Publication
(10) Pub. No.: US 2011/0303251 A1
(43) Pub. Date: Dec. 15, 2011

(54) System for Cleaning, Sterilizing and Warming Containers and Food

(76) Inventor: Megan Elizabeth Lumley, Horningsea Park (AU)

(21) Appl. No.: 12/813,396

(22) Filed: Jun. 10, 2010

(51) Int. Cl. B08B 3/04; B08B 3/14; B08B 3/10

(52) U.S. Cl. 134/56 D; 134/104.2; 134/104.4

(57) ABSTRACT

A device for washing, sterilizing and warming one or more containers comprises a main compartment, a support, a heating plate, and a dispensing mechanism. The main compartment comprises an internal cavity having a bottom surface and a drain. The main compartment is in communication with a fluid source. The support is disposed in the main compartment and is configured to accommodate one or more containers within the internal cavity of the main compartment. The heating plate is disposed on the bottom surface of the internal cavity and configured to operate in accordance with at least a first and second temperature setting. The dispensing mechanism is coupled to the main compartment and configured to discharge the fluid within the main compartment.

### FIELD OF THE INVENTION

The present invention relates to a device for washing, sterilizing and warming containers for food.

### BACKGROUND

Bottle-fed babies typically require an average of 6-8 bottles of milk per day. These bottles not only need to be washed and sterilized, they also need to be warmed prior to feeding. The washing is typically accomplished manually or by a dishwasher. A separate device is then used to sterilize the washed bottles. Once sterilized, the bottles may be filled with milk and warmed in yet another separate device for warming.

The washing, sterilizing and warming of bottles are not only time-consuming tasks, they may require up to three separate devices. In addition, these tasks are often difficult to perform outside of the house, such as when one is traveling with a baby. It is impractical to pack all of the necessarily equipment for the performance of these tasks for travel. It is therefore desirable to have a single, portable device that is capable of performing all three functions in an efficient manner.

### SUMMARY

The devices disclosed herein have the advantages of being portable, generally safe and having all of the functionality required to prepare and serve containers for food.

In one embodiment, a device for washing, sterilizing and warming one or more containers is described. The device comprises a main compartment comprising an internal cavity having a bottom surface and a drain. The main compartment is in communication with a fluid source. A support is disposed in the main compartment and is configured to accommodate one or more containers within the internal cavity of the main compartment. A heating plate is disposed on the bottom surface of the internal cavity. The heating plate is configured to operate in accordance with at least a first and second temperature setting. A dispensing mechanism is coupled to the main compartment. The dispensing mechanism is configured to discharge the fluid within the main compartment.

In accordance with one aspect of the embodiment, the first temperature setting of the heating plate is sufficient to heat the fluid to a temperature below its boiling point.

In accordance with a second aspect of the embodiment, the second temperature setting of the heating plate is sufficient to heat the fluid to a temperature at or above its boiling point.

In accordance with a third aspect of the embodiment, the dispensing mechanism discharges the fluid within the main compartment when the heating plate is configured to operate in accordance with the first temperature setting.

In accordance with a fourth aspect of the embodiment, the device further comprising a motor to pump the fluid into the dispensing mechanism and discharge the fluid from the dispensing mechanism.

In accordance with a fifth aspect of the embodiment, the dispensing mechanism is a rotating arm comprising multiple spray jets.

In another embodiment, a device for washing, sterilizing and warming one or more containers is described. The device comprises a first compartment, a main compartment, a second compartment, and a heating plate. The first compartment is configured to store water. The main compartment in fluid communication with the first compartment and comprises an internal cavity having a bottom surface, a container support, a dispensing arm, and a drain. The dispensing arm is configured to discharge water within the internal cavity and the drain configured to draw the water out of the internal cavity. The second compartment coupled to the drain to store the water drawn out of the internal cavity. The heating plate is disposed on the bottom surface of the internal cavity and is configured to heat the water within the internal cavity.

In accordance with a first aspect of the embodiment, the device further comprises a filter to recycle the fluid in the main compartment.

In accordance with a second aspect of the embodiment, the device further comprises a thermometer to indicate the internal cavity temperature.

In accordance with a third aspect of the embodiment, the device further comprises an ultraviolet light source for generating ultraviolet radiation in the internal cavity.

In accordance with a fourth aspect of the embodiment, the device further comprises an ultrasonic motor for generating ultrasonic waves in the internal cavity.

In a further embodiment, a system for washing, sterilizing and warming one or more containers is described. The system comprises a main compartment, a heating plate, a dispensing mechanism, and a plurality of supports. The main compartment is in communication with a water source and comprises an internal cavity, an external body and a drain. The internal cavity has a bottom surface and the external body comprises an upper surface. The drain is in communication with the internal cavity. The heating plate is disposed on the bottom surface of the internal cavity and is configured to operate in accordance with at least a first and second temperature setting. The dispensing mechanism is coupled to the main compartment and configured to discharge the fluid within the main compartment. The plurality of supports are each configured to be positioned in the internal cavity. Lids are provided for the plurality of supports. The upper surface of the main compartment is configured to support at least one of the plurality of supports.

Other objects, features and advantages of the present invention will become apparent to those skilled in the art from the following detailed description.

### BRIEF DESCRIPTION OF THE DRAWINGS

Illustrative embodiments of the present invention are described herein with reference to the accompanying drawings, in which:

FIG. 1 is a perspective view of an embodiment of a device for cleaning, sterilizing and warming containers and food in the washing stage.

FIG. 2 is a perspective view of the device in FIG. 1 in the sterilizing stage.

FIG. 3 is a perspective view of the device in FIG. 1 in the warming stage.

FIG. 4 is a plan view of a support configured to be placed in the main compartment of the device.

FIG. 5 is a perspective view of another embodiment of a device for cleaning, sterilizing and warming containers and food.

FIG. 6 is a perspective view of the device in FIG. 5 with additional supports stacked on top of the device for storage.

Like numerals refer to like parts throughout the several views of the drawings.

### DETAILED DESCRIPTION OF THE PREFERRED EMBODIMENTS

Combining the three processes of washing, sterilizing and warming of the food and containers provides a comprehensive and complete range of functions to support nursing mothers and other healthcare situations.

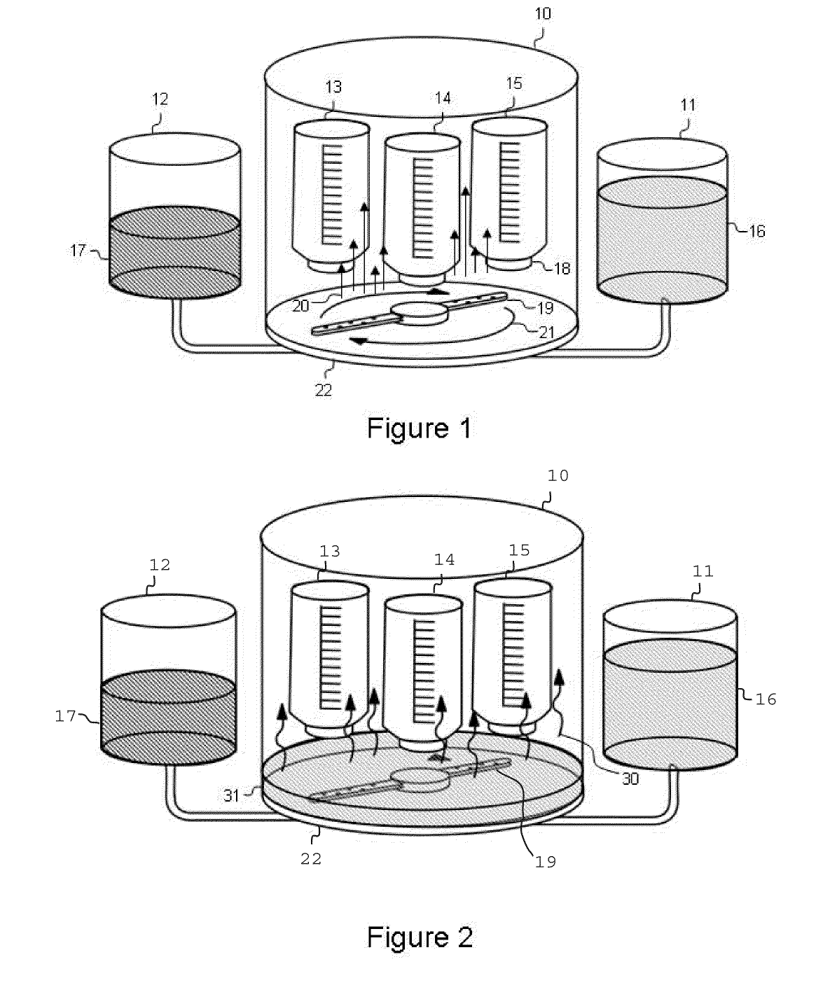

FIG. 1 depicts the washing cycle of an embodiment which is the first of three cycles used in this device that include washing, sterilizing and warming. The embodiment includes three compartments 10, 11, 12. The main compartment 10 is sealed and enclosed enabling hot water to be sprayed 20 throughout the compartment 10 during the cleaning cycle. This compartment is used for washing, sterilizing and warming food containers. While the embodiments disclosed herein describe the device for use with three food containers, it is understood that the device may be configured for any number of items or containers that need washing, sterilization and warming.

A first compartment 11 contains clean water 16 to be used during the washing, sterilizing and warming cycles. This water 16 is pumped as needed into the main compartment 10.

A second compartment 12 is used to store waste water 17 until it is conveniently disposed of. The waste water 17 includes items removed from dirty items that are washed in the main compartment 10 during the washing cycle.

While the embodiment describes the use of portable fresh and waste water containers to make the unit transportable and make it available for use in a nursery where plumbing outlets and drains may not be available, an alternative embodiment may attach the main compartment to mains water and the water waste may be connected directly to the drain or other water waste system.

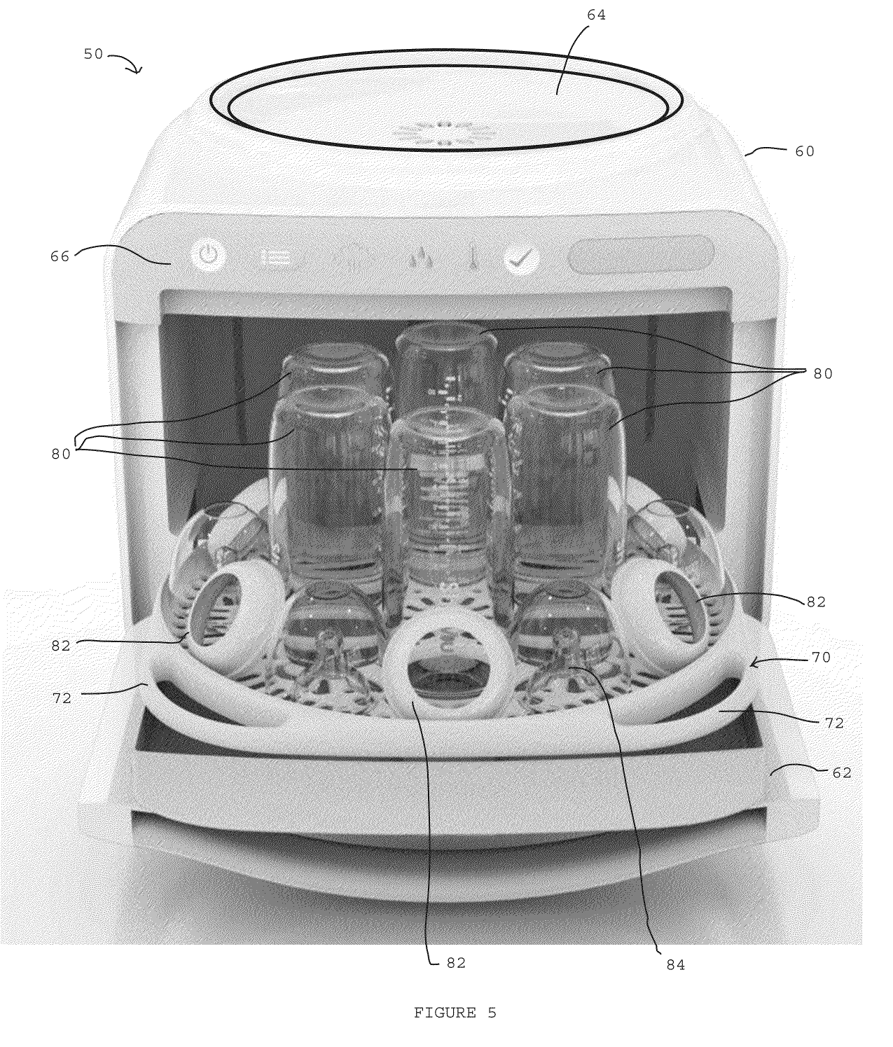

During the initial washing cycle clean water 16 is pumped from the clean water compartment 11 at high pressure through a rotating 21 spray mechanism 19 at the bottom of the main compartment 10 that causes jets of water 20 to clean all surfaces of the containers 13, 14, enclosed in the main compartment 10 as it is mixed with a cleaning agent released from the bottom of the compartment. FIG. 4 depicts a support that is configured to suspend the containers 13, 14, 15 and any other items in the main compartment 10 for cleaning.

While the embodiment describes a rotating spray mechanism for cleaning, alternative embodiments are contemplated within the scope of the embodiment which utilizes any variety of spraying water so as to provide a cleaning effect. Moreover, other embodiments may supplant or replace the spray mechanism with alternative cleaning methods such as ultrasonic cleaning or ultraviolet radiation.

In addition the base 22 of the main compartment 10 contains a heating plate that may be set to heat the washing water to further aid in the cleaning process. A filtered recycling system may be used to allow wash water 16 to be reused to clean the containers 13, 14, 15 and other items in the cleaning space 10. This filtered recycling system may be optionally used to reduce the amount of fresh water 16 pumped from the fresh water compartment 11 used during the cleaning cycle. Although the water heating system disclosed in the embodiment use an enclosed heating plate in the base of the main compartment, an alternative embodiment may utilize any other water heating method to aid in heating water to assist in the cleaning, sterilizing or warming of containers or food.

The used and dirty water at the bottom of the main compartment 10 that results from the washing cycle is pumped out of the cleaning space 10 to the waste water container 12 for temporary storage 17 until it may be conveniently disposed of. More clean water 16 may be pumped from the clean water compartment 11 to rinse the items 13, 14, 15 using the same process during washing but without the addition of cleaning solution. The resulting rinse cycle water in the bottom of the main compartment 10 may be removed to the waste water compartment 12 for later disposal.

FIG. 2 discloses the sterilization cycle of the device. In this cycle clean water is pumped from the clean water compartment 11 at low pressure into the area at the base of the main compartment 31. The main compartment may be vented to allow for release of steam pressure. The sterilization cycle in the example embodiment uses steam. Alternative sterilization methods include, but are not limited to, the use of ultraviolet light and or ultrasonic waves.

The heating plate in the base 22 of the main compartment 10 may be set to heat the water to a temperature that allows the water to turn into steam 30 and is at a high enough temperature to perform a sterilization of the containers and other items in the main compartment 10. With the application of steam over a predetermined period of time the sterilization of the items in the main compartment 10 is achieved.

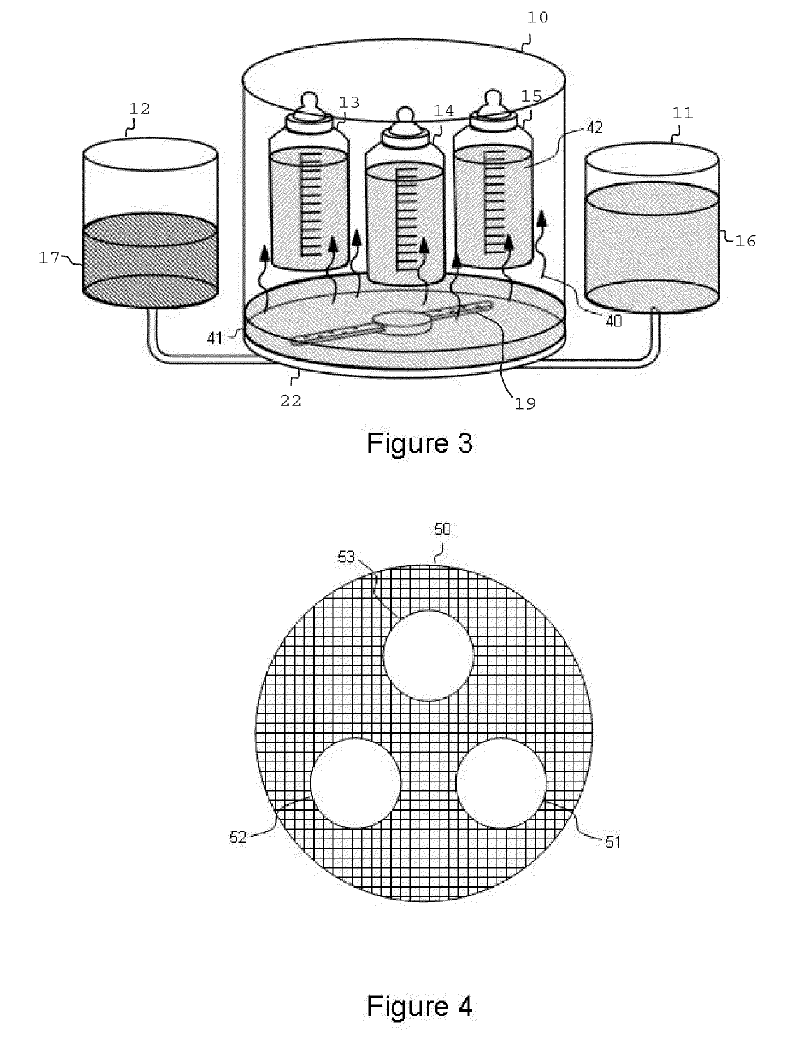

Any water remaining in the base of the main compartment 10 may be used in additional sterilization cycles of other containers or items, or alternatively in the food warming cycle of the same or other containers or items as outlined in FIG. 3. The embodiment may, as an alternate, allow the user to pump out the remaining water to the waste water compartment 12 to allow the device to be moved or placed in storage.

FIG. 3 discloses the food warming cycle. The food containers and other items are removed and food placed inside them 42 and then placed back inside the main compartment 10. Clean water from the clean water compartment 11 is pumped into the bottom of the main compartment 41 and is then heated to the point where the water turns to steam 40 and starts to heat or warm the containers and other items in the main compartment 10 as well as the food 42 contained inside them.

If the main compartment 10 already has a level of water in it from a previous cycle, such as the sterilization cycle mentioned in reference to FIG. 2, the water level may be topped up or raised by the addition of water from the clean water compartment 11 until the desired level of water is reached prior to heating for the production of steam that is in turn used to warm the containers, items and food contained therein.

While the described embodiment uses one main compartment for all cycles of use for the device, an alternative embodiment may provide for the stacking of additional cleaning compartments on top of the base compartment for one or more cycles of operation. Further, while the embodiment describes the use of steam to warm the food containers, it is understood that alternative warming methods may be used, such as warming the food by immersion in warm to hot water or using an element encased in molded plastic designed to withstand high temperatures, by which the container is placed into the fitted shape of the molded plastic.

FIG. 4 discloses an embodiment of a support 50 to be used in the main compartment 10 for holding containers 13, 14, 15 in such a way so as to allow them to be efficiently cleaned, sterilized and warmed. The support 50 contains circular holes 51, 52, 53 that are designed to suspend containers such as baby bottles so that they may be cleaned, sterilized and warmed. The support 50 also features a structural design, in this case an open grid allows cleaning agent, spray water 20 and steam 30 to easily pass through the support from the bottom to the top of the compartment 10 while retaining enough strength to suspend the items to be cleaned, sterilized and warmed. While the described embodiment uses a support 50 in the main compartment that uses a structure configured in a grid to maintain strength, alternative embodiments are possible. For example, any structure that maintains the strength of the support while allowing water and steam to freely move around the compartment may be used.

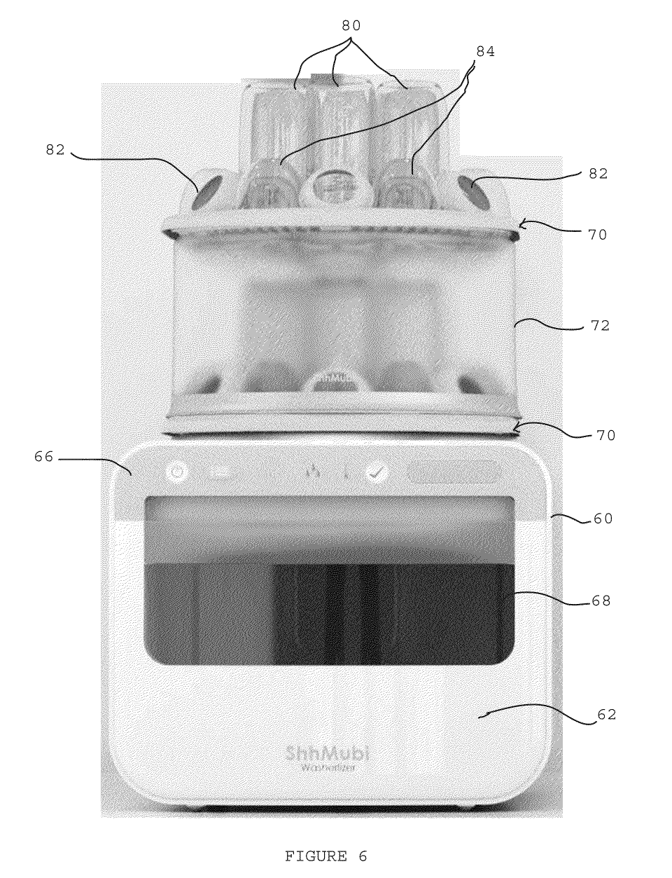

FIGS. 5 and 6 depict another embodiment of a device 50 for cleaning, sterilizing and warming containers and food. The device comprises a main compartment 60 which are coupled to a water source (not shown). The main compartment 60 comprises a pivotally attached door 62 having a transparent panel 68 (as shown in FIG. 6) to allow the user to view the internal cavity of the main compartment 60 during operation of the device. A control panel 66 is provided to enable the user to turn the device on and to select either one or all of the washing, sterilizing or warming functions.

One or more supports 70 may be provided with the device 50. As shown in FIG. 5, the support 70 may be loaded with a plurality of bottles 80, rings 82 and nipples 84, among other things. The support 70 may be especially configured to hold these items in place (80, 82, 84) and prevent them from being disengaged from the support 70 during the washing cycle. The loaded support 70 may be inserted into the main compartment 60 for washing and sterilizing. The support 70 may further be provided for handles 72 for ease of handling.

Once the washing and sterilization cycles have been completed, the support 70 may be removed from the main compartment 60. A lid 72 may be placed on top of the support 70 to maintain the sterility of the items and stacked on top of the main compartment 60. As shown in FIG. 5, the main compartment 70 may comprise an upper surface 64 that is configured to engage and maintain the support 70 thereon. As shown in FIG. 6, additional supports 70 may be stacked on top of the lid 72. While not shown in FIGS. 5 and 6, it is understood that the supports 70 may also be used to support containers of food within the main compartment during the warming phase.

It is to be understood that the detailed description and specific examples, while indicating preferred embodiments of the present invention, are given by way of illustration and not limitation. Many changes and modifications within the scope of the present invention may be made without departing from the spirit thereof, and the invention includes all such modifications.

What is claimed is:

1. A device for washing, sterilizing and warming one or more containers comprising:
a main compartment comprising an internal cavity having a bottom surface and a drain, the main compartment in communication with a fluid source;
a support disposed in the main compartment, the support being configured to accommodate one or more containers within the internal cavity of the main compartment;
a heating plate disposed on the bottom surface of the internal cavity, the heating plate configured to operate in accordance with at least a first and second temperature setting; and
a dispensing mechanism coupled to the main compartment, the dispensing mechanism configured to discharge the fluid within the main compartment.

2. The device of claim 1, wherein the first temperature setting of the heating plate is sufficient to heat the fluid to a temperature below its boiling point.

3. The device of claim 1, wherein the second temperature setting of the heating plate is sufficient to heat the fluid to a temperature at or above its boiling point.

4. The device of claim 1, wherein the dispensing mechanism discharges the fluid within the main compartment when the heating plate is configured to operate in accordance with the first temperature setting.

5. The device of claim 1 further comprising a motor to pump the fluid into the dispensing mechanism and discharge the fluid from the dispensing mechanism.

6. The device of claim 5, wherein the dispensing mechanism is a rotating arm comprising multiple spray jets.

7. A device for washing, sterilizing and warming one or more containers comprising:
a first compartment configured to store water;
a main compartment in fluid communication with the first compartment, the main compartment comprising an internal cavity having a bottom surface, a container support, a dispensing arm and a drain, the dispensing arm configured to discharge water within the internal cavity and the drain configured to draw the water out of the internal cavity;
a second compartment coupled to the drain to store the water drawn out of the internal cavity; and
a heating plate disposed on the bottom surface of the internal cavity, the heating plate configured to heat the water within the internal cavity.

8. The device of claim 1 further comprising a filter to recycle the fluid in the main compartment.

9. The device of claim 1 further comprising a thermometer to indicate the internal cavity temperature.

10. The device of claim 1 further comprising an ultraviolet light source for generating ultraviolet radiation in the internal cavity.

11. The device of claim 1 further comprising an ultrasonic motor for generating ultrasonic waves in the internal cavity.

12. A system for washing, sterilizing and warming one or more containers comprising:
a main compartment comprising an internal cavity having a bottom surface, an external body comprising an upper surface, and a drain in communication with the internal cavity, the main compartment in communication with a water source;
a heating plate disposed on the bottom surface of the internal cavity, the heating plate configured to operate in accordance with at least a first and second temperature setting;
a dispensing mechanism coupled to the main compartment, the dispensing mechanism configured to discharge the fluid within the main compartment; and
a plurality of supports, the plurality of supports each configured to be positioned in the internal cavity and lids for at least one of the plurality of supports;
wherein the upper surface of the main compartment is configured to support at least one of the plurality of supports.
